(19) United States
(12) Patent Application Publication
(10) Pub. No.: US 2025/0050845 A1
(43) Pub. Date: Feb. 13, 2025

(54) ELECTROMECHANICAL ACTUATOR FOR A BRAKING SYSTEM OF A VEHICLE, BRAKING SYSTEM AND VEHICLE

(71) Applicant: Faiveley Transport Italia S.P.A., Piossasco (Torino) (IT)

(72) Inventors: Matteo Frea, Cantalupa, Torino (IT); Roberto Tione, Lauriano, Torino (IT)

(73) Assignee: Faiveley Transport Italia S.P.A., Piossasco (Torino) (IT)

(21) Appl. No.: 18/720,784

(22) PCT Filed: Dec. 16, 2022
(86) PCT No.: PCT/IB2022/062355

§ 371 Date: Jun. 17, 2024

(30) Foreign Application Priority Data
Dec. 16, 2021 (IT) 102021000031565

(51) Int. Cl. B60T 8/17; B60T 8/32; B60T 13/74

(52) U.S. Cl. CPC B60T 8/1705; B60T 8/3235; B60T 8/329; B60T 13/741

(57) ABSTRACT

An electromechanical actuator (200) for a braking system of a vehicle (V), particularly a railway vehicle, is described, characterized in that it includes a first control means (202) arranged to receive from a speed sensor means (204, 204′), associated with a wheel (w) of the vehicle, a speed signal having a value indicative of an angular speed of the wheel (w) of the vehicle.

A braking system and a vehicle are also described.

### TECHNICAL FIELD

The present invention relates, in general, to the vehicle sector; in particular, the invention relates to an electromechanical actuator for a braking system of a vehicle, to a braking system and to a vehicle.

### PRIOR ART

In the prior art, a typical solution includes determining the forward speed of a vehicle on the basis of at least one angular speed of a wheel, or of an axle coupled to such wheel.

To prevent the determination of the forward speed of the vehicle from being compromised by a wheel skidding condition (i.e. a condition in which the forward speed of the vehicle is greater than the speed value given by multiplying the angular speed of the wheel by the radius of this wheel) or by a locking condition (i.e. a condition in which the wheel has a substantially zero angular speed even if the vehicle is moving), the determination of the forward speed of the vehicle may be obtained on the basis of a plurality of angular speeds obtained from a plurality of wheels.

Knowing the forward speed of the vehicle is extremely important.

For example, knowing the forward speed of the vehicle and the angular speed of one or more wheels allows the skidding condition of a wheel to be determined. In the prior art, a multitude of functions for managing skidding of a wheel are known.

In the prior art, as for example observable in FIG. 1, the angular speed of each wheel w to be monitored may be obtained starting from a respective speed sensor means 100 arranged to measure an angular speed value of the respective wheel w.

A speed signal generated by this speed sensor means 100 is forwarded to at least one central unit/control unit 102 located on board the vehicle v.

This central unit/control unit 102, being arranged on board the vehicle, is remote and distant from the speed sensor means 100 and from the wheel w. Therefore, the speed signal is carried by the speed sensor means 100 to said central unit/control unit 102 on board the vehicle by means of long cables 101. This aspect is particularly relevant for example for large vehicles, such as for example railway vehicles or railway convoys.

The use of long cables 101 leads to at least the following problems:
design problems related to the definition of the cable arrangement in the vehicle;
problems related to the high difficulty of installing the cables along the vehicle;
high design and installation costs;
long cables carrying a weak analog signal are subject to disturbances, and therefore, since the speed signal carries extremely important data, which also impacts on vehicle safety, it is necessary to use expensive shielded cables.

With reference for example to the railway transport system, the fact that the control means to which the speed signal deriving from the sensor means coupled to a wheel must be transmitted is installed on board the train, and therefore far from the speed sensor means, depends also on the fact that the most used known braking systems are pneumatic systems, since they are extremely safe. These pneumatic systems use compressed air suitably injected into brake cylinders to generate braking force. This compressed air is generated by one or more compressors.

Disadvantageously, in pneumatic braking systems, the elements closest to the speed sensor are pneumatic elements without electronic control means, such as for example pneumatic cylinders. Therefore, also in the field of railway vehicles, the speed signal is carried by the speed sensor means to said central unit/control unit on board the vehicle by means of long cables.

However, it is known that the technology for producing compressed air has several drawbacks:
the overall efficiency of a compressor is extremely low, much less than 50%, and represents a huge consumption of irrecoverable energy;
the compressor is a source of noise, both towards the environment occupied by the passengers and towards the external environment, and requires significant soundproofing measures;
the compressor is a source of vibrations which are transmitted to the vehicle body, causing further vibrations and noise in the environment occupied by the passengers;
the compressor, its support frame, and the soundproofing enclosures for passive noise reduction represent a huge mass amounting to several hundred kilograms, constituting further energy inefficiency when calculating the energy necessary to accelerate the railway vehicle;
the compressor has a relatively frequent, intrusive, and above all costly maintenance cycle.

A compressed air braking system further requires the use of dryers to remove the moisture from the compressed air, which dryers are characterized by a frequent, intrusive, and costly maintenance cycle. In addition, the compressed air braking system requires reservoirs for storing compressed air and pipes for distributing compressed air. Both the tanks and the pipes represent an additional cost, bulk, and weight.

Therefore, a known alternative solution to pneumatic braking systems of recent conception is represented by the use of electromechanical actuators, in order to replace the current compressed air actuators.

At present, an exemplary electromechanical actuator generally includes one or more electric motors integrated in the electromechanical actuator itself and mechanical elements through which the one or more motors may perform for example one or more of the following two functions:
applying and releasing the braking force;
loading a spring with a sufficient amount of energy to apply at least one autonomous braking in the event of a loss of electrical energy or in the event of a request for emergency braking, this being necessary since the electronic control of one or more motors is not considered sufficiently safe.

### SUMMARY OF THE INVENTION

An object of the present invention is therefore to provide a solution which allows the transmission of a speed signal coming from a speed sensor means associated with a wheel of a vehicle to a control means by means of wiring which is as short as possible, in order to keep the design difficulty of such wiring low, and in order to obtain a clean speed signal, which is more resistant to any disturbances/interferences.

The aforesaid and other objects and advantages are achieved, according to an aspect of the invention, by an electromechanical actuator having the features defined in claim 1, by a braking system having the features defined in claim 13, and by a vehicle having the features defined in claim 14. Preferred embodiments of the invention are defined in the dependent claims, the content of which is to be understood as an integral part of the present description.

In summary, the present invention is based on exploiting the presence of electromechanical actuators which are installed close to a wheel of the vehicle and which include within them at least one electronic control means. The installation position of the electromechanical actuators with respect to a wheel and the fact that they include at least one electronic control part mean that the electromechanical actuators are advantageously usable for receiving a speed signal coming from a sensor means coupled to such a wheel.

### BRIEF DESCRIPTION OF THE DRAWINGS

The functional and structural features of some preferred embodiments of an electromechanical actuator, of a braking system and of a vehicle according to the invention will now be described. Reference is made to the accompanying drawings, in which:

FIG. 1 shows a solution implemented according to the prior art;

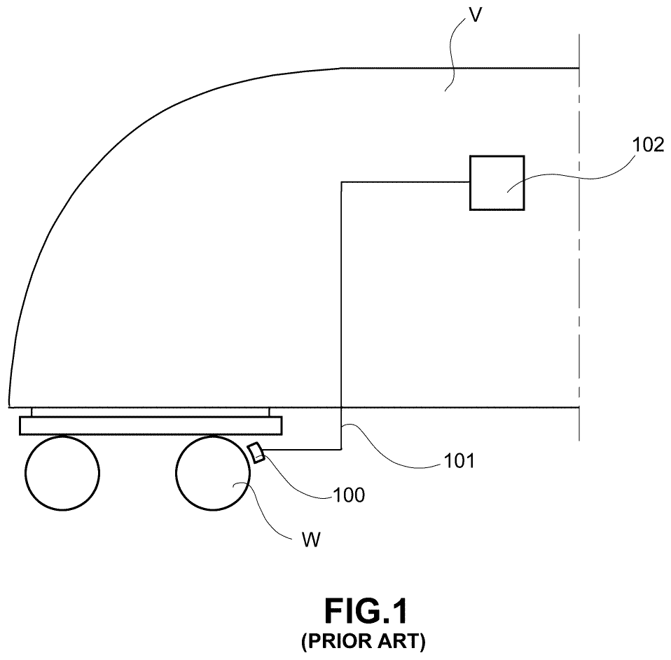

FIG. 2a shows an embodiment of an electromechanical actuator according to the present invention;

FIG. 2b shows a further embodiment of an electromechanical actuator according to the present invention;

FIG. 3 shows yet another embodiment of an electromechanical actuator according to the present invention;

FIG. 4 shows an embodiment of a braking system according to the present invention; and

FIG. 5 shows an embodiment of a vehicle according to the present invention.

### DETAILED DESCRIPTION

Before explaining in detail a plurality of embodiments of the invention, it should be clarified that the invention is not limited in its application to the design details and configuration of the components presented in the following description or illustrated in the drawings. The invention may assume other embodiments and be implemented or constructed in practice in different ways. It should also be understood that the phraseology and terminology have a descriptive purpose and should not be construed as limiting. The use of “include” and “comprise” and the variations thereof are intended to cover the elements set out below and their equivalents, as well as additional elements and the equivalents thereof.

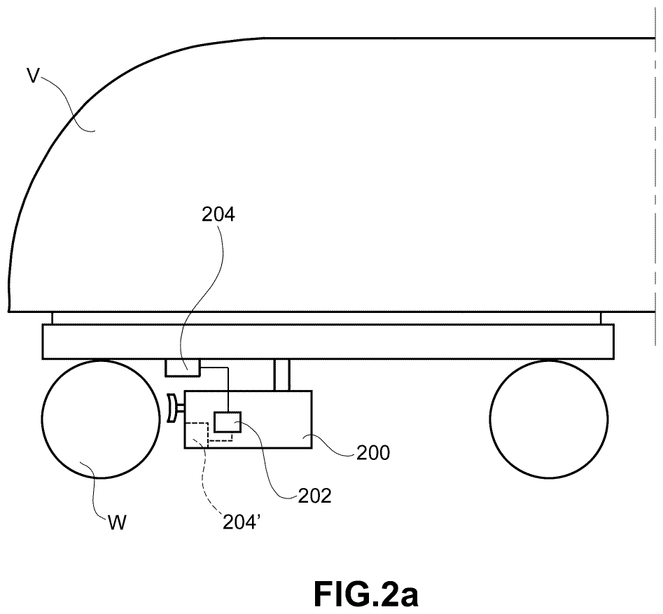

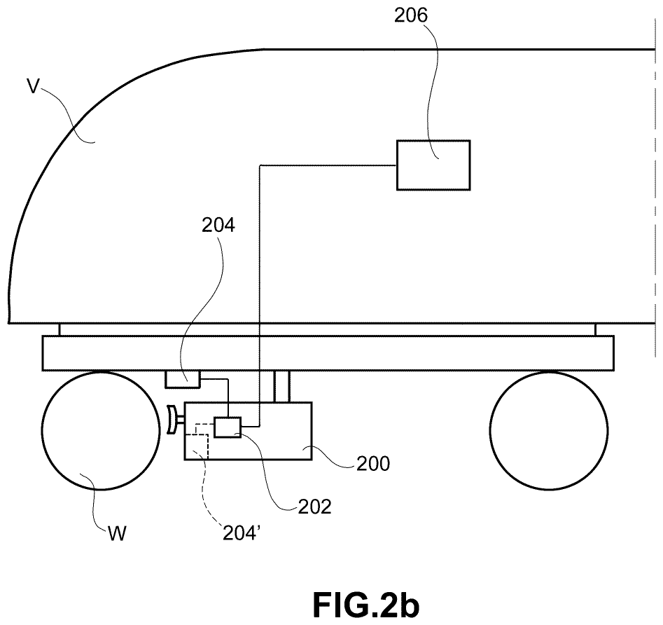

In a first embodiment, as illustrated by way of example in FIG. 2a, an electromechanical actuator 200 for a braking system of a vehicle v, particularly a railway vehicle, includes a first control means 202 arranged to receive from a speed sensor means 204, 204′, associated with a wheel w of the vehicle, a speed signal having a value indicative of an angular speed of said wheel w of said vehicle.

In other words, a value of the speed signal is indicative of an angular speed of said wheel w of said vehicle. For example, the value of the speed signal indicative of the angular speed of said wheel may be for example a frequency value of the signal or an amplitude value, etc.

For example, preferably, the first control means 202 of the electromechanical actuator 200 may be a control means further arranged to manage the conversion of electrical control signals into a corresponding braking force applied by the electromechanical actuator. Or, preferably, the first control means 202 may be a suitable control means provided to perform suitable functions related to the speed signal received, independently of the conversion of the electric control signals into the corresponding braking force applied by the electromechanical actuator 200. The examples just described are not limiting, and in further examples, the first control means 202 may be arranged to also perform other functions related to the generation/control of the braking force generated by the electromechanical actuator 200.

Preferably, the speed sensor means 204′ may be included directly in the electromechanical actuator 200. In other words, the speed sensor means may be integrated into the electromechanical actuator.

Or, preferably, the speed sensor means 204 may be associated with the electromechanical actuator 200. For example, the speed sensor means may be external to the electromechanical actuator but may be associated/connected to the speed sensor means via a connection means. Preferably, this connection means may be a wired connection means or a wireless connection means. For interference reasons, shielded cables may still be used for wired connections. Advantageously, unlike the prior art, the length of the cables may be reduced to a minimum by virtue of the proximity of the speed sensor means and of the wheel with respect to the electromechanical actuator.

Preferably, the speed sensor means 204, 204′ may be an angular speed sensor.

Preferably, the speed sensor means 204, 204′ may be arranged to generate the speed signal as a function of an angular speed of a phonic wheel associated to said wheel w of the vehicle.

As may be seen in FIG. 2b, in one embodiment, the electromechanical actuator 200 may be arranged to transmit the speed signal received (i.e. coming) from the speed sensor means to a second control means 206. Or, the electromechanical actuator 200 may be arranged to transmit the angular speed value indicated by the speed signal received (i.e. coming) from the speed sensor means 204, 204′ to a second control means installed on board the vehicle. In this second case, for example, the first control means may derive the angular speed value indicated by the received speed signal and directly transmit the derived angular speed value to the second control means.

Preferably, the second control means 206 may be arranged to adjust a value of a braking force generated by said electromechanical actuator 200.

For example, the second control means 206 may be the control means in charge of controlling the electromechanical actuator and the braking force associated therewith. By way of example, the second control means may receive control signals indicative of the controls given by a driver of the vehicle or control signals coming from automatic control systems on board the vehicle. Automatic control systems may be for example autonomous driving systems.

Preferably, the first control means 202 and/or the second control means 206 may be or include at least one among a microprocessor, processor, microcontroller, controller, PLC, FPGA, control unit, control system or control device.

Preferably, the second control means 206 may be arranged to perform an anti-skid function of the wheel w of the vehicle. The anti-skid function may be arranged to determine that the wheel is skidding as a function of the speed signal value received by the second control means or of the angular speed value received by the second control means. In the present invention, the anti-skid function may be any anti-skid function known in the vehicle industry.

In other words, the electromechanical actuator 200 may forward the speed signal, or the angular speed value indicated by the speed signal, to the second control means 206, which will be in charge of managing the anti-skid function.

In a further embodiment, when the first control means transmits the speed signal received (i.e. coming) from the speed sensor means 204, 204′ to the second control means 206, the second control means 206 may be arranged to provide a vehicle linear speed estimate determined on the basis of the value of such speed signal. In this case, the first control means 202 may also be arranged to:
receive the vehicle linear speed estimate;
determine that the wheel is skidding from the vehicle linear speed estimate; and
when it determines that the wheel is skidding, perform an anti-skid function of the wheel of the vehicle.

Or, when the first control means transmits the angular speed value indicated by the received speed signal to the second control means, the second control means may be arranged to provide a vehicle linear speed estimate determined on the basis of said received angular speed value. The first control means 202 may be further arranged to:
receive said vehicle linear speed estimate;
determine that the wheel w is skidding from said vehicle linear speed estimate;
when it determines that the wheel w is skidding, perform an anti-skid function of the wheel of the vehicle.

In other words, the electromechanical actuator 200 may forward the speed signal, or the angular speed value indicated by the speed signal received, to the second control means 206, which will be in charge of estimating the forward speed of the vehicle. In one example, the second control means 206 will be able to receive the speed signals or the angular speed values also from further electromechanical actuators associated with respective wheels. In this way, the estimate of the forward speed of the vehicle may be more precise and reliable as it is derived from the angular speeds of a plurality of wheels of the vehicle. Subsequently, the second control means 206 will be able to forward the forward speed estimate to the first control means 202, which will take care of managing the anti-skid function. Therefore, each electromechanical actuator 200 may be in charge of managing the anti-skid of the wheel with which it is associated. This aspect has the further advantage of having distributed management of the anti-skid function. By having distributed management of the anti-skid function, even if an electromechanical actuator is no longer able to perform its anti-skid function, the other actuators will be able to continue to perform their anti-skid function autonomously, so as to guarantee a high degree of availability and safety of the management of the anti-skid function. Also in this case, the anti-skid function may be any anti-skid function known in the vehicle industry.

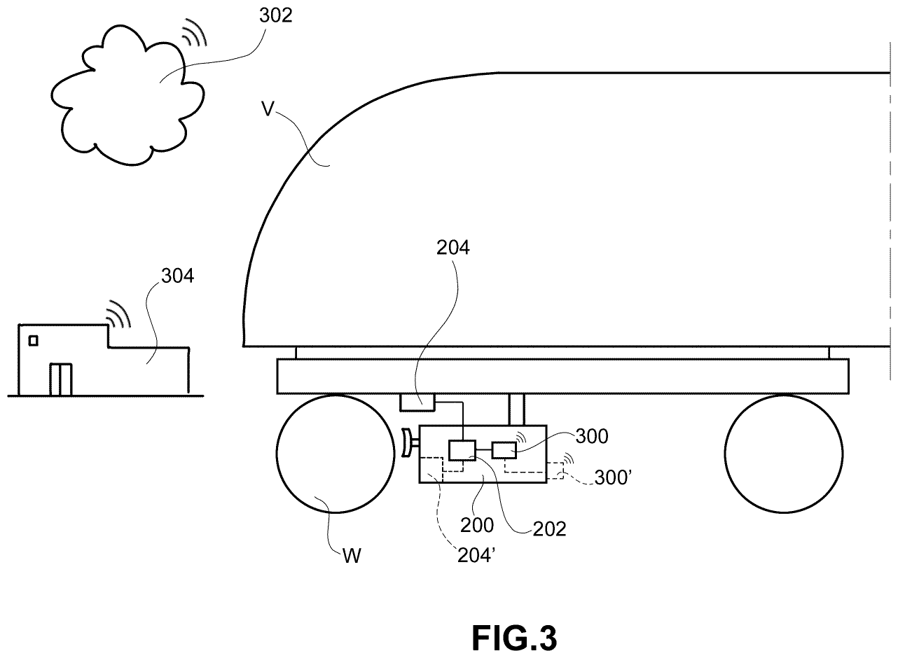

Preferably, as exemplarily illustrated in FIG. 3, the electromechanical actuator 200 may include communication means 300 or be associated with communication means 300′. In this case, the electromechanical actuator 200 may be arranged to transmit, through said communication means, the speed signal received (i.e. coming) from the speed sensor means to a cloud 302 or to a ground station 304. Or, the electromechanical actuator 200 may be arranged to transmit, via the communication means 300, 300′, the angular speed value indicated by the speed signal received (i.e. coming) from the speed sensor means 204, 204′ to a ground station 304 or to a cloud 302.

Preferably, the communication means 300, 300′ may be wireless communication means. For example, the communication means 300, 300′ may include at least one Bluetooth communication device or a wireless communication device, or the like.

Preferably, the electromechanical actuator 200 may include an energy storage means arranged to store energy. The energy stored in the energy storage means may be sufficient to actuate the electromechanical actuator to cause the braking system to perform at least one emergency braking action or service or parking action.

The release of the energy stored in the energy storage means may be controlled as a function of the value of the speed signal which the electromechanical actuator has received from the speed sensor means. For example, the release of the energy stored in the energy storage means may be controlled by the first control means, or by the second control means, or by a further dedicated control means associated with the energy storage means.

Preferably, the energy storage means may include at least one of:
a flywheel;
a super-capacitor;
a battery;
a spring.

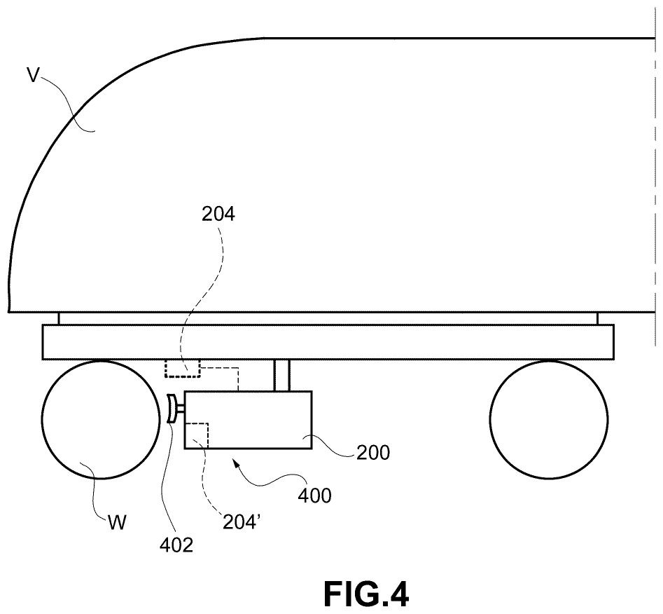

The present invention also relates to a braking system. As may be seen by way of example in FIG. 4, in one embodiment, the braking system 400 includes:
an electromechanical actuator 200 according to any one of the preceding embodiments;
braking means arranged to be actuated by said electromechanical actuator 200.

Preferably, the braking means may include or be an air brake, electropneumatic brake, electromechanical brake, electromagnetic brake, magnetic brake, friction brake, or any type of brake that may be used in a vehicle.

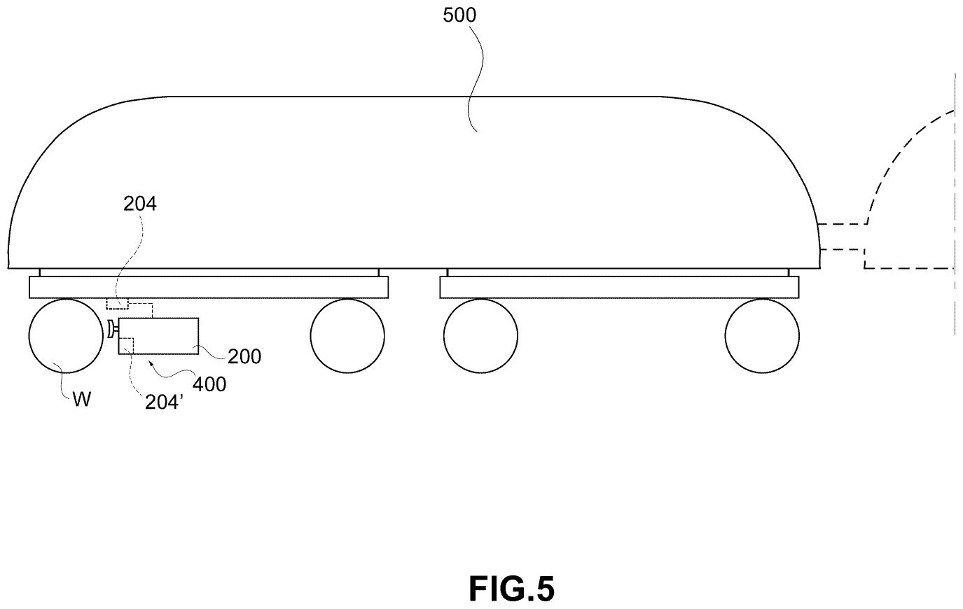

In a still further aspect, the invention relates to a vehicle. As may be seen by way of example in FIG. 5, in one embodiment, the vehicle 500 includes:
at least one wheel;
at least one speed sensor means arranged to generate a speed signal having a value indicative of an angular speed of said at least one wheel w;
a braking system according to the embodiments described above.

Preferably, the vehicle may be a railway vehicle or a railway convoy.

As described above, this invention may preferably be applied to at least one railway vehicle travelling on railway tracks. For example, a vehicle as referred to herein may be a locomotive, and a course/route may include tracks on which the wheels of the locomotive roll. The embodiments described herein are not intended to be limited to vehicles on tracks. For example, the vehicle may be a car, a truck (for example a highway semi-trailer truck, a mining truck, a truck for transporting timber or the like), a motorcycle or the like, and the route may be a road or a trail.

The advantage achieved is that of having provided a solution which allows the transmission of a speed signal coming from a speed sensor means associated with a wheel of a vehicle to a control means by means of wiring which is as short as possible, keeping the design difficulty of such wiring low, and obtaining a clean speed signal, which is more resistant to any disturbances/interferences.

Various aspects and embodiments of an electromechanical actuator, of a braking system and of a vehicle according to the invention have been described. It is understood that each embodiment may be combined with any other embodiment. Moreover, the invention is not limited to the embodiments described, but may be varied within the scope defined by the appended claims.

1. An electromechanical actuator for a braking system of a vehicle, comprising:
a first control circuit configured to receive, from a speed sensor associated with a wheel of said vehicle, a speed signal having a value indicative of an angular speed of said wheel of said vehicle.

2. The electromechanical actuator of claim 1, wherein said speed sensor is included in said electromechanical actuator (200).

3. The electromechanical actuator of claim 1, wherein said speed sensor is an angular speed sensor.

4. The electromechanical actuator of claim 1, wherein said speed sensor is configured to generate the speed signal as a function of an angular speed of a phonic wheel associated with said wheel of the vehicle.

5. The electromechanical actuator of claim 1, wherein said electromechanical actuator is configured to:
transmit the speed signal received from the speed sensor to a second control circuit installed in the vehicle; or
transmit an angular speed value indicated by the speed signal received from the speed sensor to a second control circuit installed in the vehicle.

6. The electromechanical actuator of claim 5, wherein said first control circuit is configured to receive a breaking signal from said second control circuit to adjust a value of a braking force generated by said electromechanical actuator.

7. The electromechanical actuator of claim 6, wherein said second control circuit is configured to to determine that the wheel is skidding based on the speed signal received by the second control circuit or the angular speed value received by the second control circuit.

8. The electromechanical actuator of claim 6, wherein, when said first control circuit is configured to transmit the speed signal received from the speed sensor to the second control circuit, wherein the second control circuit is configured to provide a vehicle linear speed estimate determined based on said speed signal or said angular speed value;
wherein the first control circuit if further configured to:
receive said vehicle linear speed estimate;
determine that the wheel is skidding based on said vehicle linear speed estimate; and
perform an anti-skid function of the wheel of the vehicle.

9. The electromechanical actuator of claim 4, further comprising a wireless communication device.

10. The electromechanical actuator of claim 9, wherein said electromechanical actuator is further configured to:
transmit, via said wireless communication device, the speed signal received from the speed sensor to a ground station or a cloud; or
transmit, via said wireless communication device, an angular speed value indicated by the speed signal received from the speed sensor to a ground station or to a cloud.

11. The electromechanical actuator of claim 1, further comprising an energy storage means configured to store energy; wherein the energy stored in the energy storage means is sufficient to actuate the electromechanical actuator to cause the braking system to perform at least one emergency braking action or service or parking action.

12. The electromechanical actuator of claim 11, wherein said energy storage means includes at least one of:
a flywheel;
a super-capacitor;
a battery; and
a spring.

13. A braking system for a vehicle, comprising:
a speed sensor configured to sense an angular speed of a wheel of said vehicle;
an electromechanical actuator comprising a first control circuit, wherein the first control circuit is configured to receive, from the speed sensor, a speed signal comprising a value indicative of the angular speed of said wheel; and
a brake configured to be actuated by said electromechanical actuator.

14. A vehicle, comprising:
a wheel;
at least one speed sensor configured to generate a speed signal having a value indicative of an angular speed of said wheel;
an electromechanical actuator positioned proximate to said wheel, wherein said electromechanical actuator comprises a first control circuit, and wherein said first control circuit is configured to receive, from the at least one speed sensor, a speed signal comprising a value indicative of the angular speed of said wheel; and
a brake configured to be actuated by said electromechanical actuator.

15. The vehicle of claim 14, wherein said vehicle is a railway vehicle.

16. The vehicle of claim 14, further comprising a second control circuit separate from and communicatively coupled to the first control circuit, wherein said first control circuit is configured to:
transmit the speed signal received from the speed sensor to the second control circuit; or
transmit the angular speed value indicated by the speed signal received from the speed sensor to the second control circuit.

17. The vehicle of claim 16, wherein said first control circuit is configured to receive a breaking signal from said second control circuit to adjust a value of a braking force generated by said electromechanical actuator.

18. The vehicle of claim 17, wherein said second control circuit is configured to determine that the wheel is skidding based on the speed signal received from the first control circuit or the angular speed value received from the first control circuit.

19. The braking system of claim 13, wherein said first control circuit is configured to:
transmit the speed signal received from the speed sensor to a second control circuit installed in the vehicle; or
transmit the angular speed value indicated by the speed signal received from the speed sensor to a second control circuit installed in the vehicle.

20. The braking system of claim 19, wherein said first control circuit is configured to receive a breaking signal from said second control circuit to adjust a value of a braking force generated by said electromechanical actuator.
